(19) United States
(12) Patent Application Publication
(10) Pub. No.: US 2026/0170036 A1
(43) Pub. Date: Jun. 18, 2026

(54) METHODS AND SYSTEMS FOR IMPROVED BROWSER INTERACTIONS WITH AI MODELS

(71) Applicant: Shopify Inc., Ottawa (CA)

(72) Inventor: Jeremiah BRAZEAU, Andover, MA (US)

(73) Assignee: Shopify Inc., Ottawa (CA)

(21) Appl. No.: 18/984,082

(22) Filed: Dec. 17, 2024

(51) Int. Cl. G06F 16/334

(52) U.S. Cl. CPC G06F 16/3347

(57) ABSTRACT

A computer system and computer-implemented method are described. The method may include obtaining user data and a set of defined queries; generating a set of answers to the set of defined queries, the generation including causing a model to create, based on the user data and the set of defined queries, the set of answers; using an embedding model to generate a vector based on the set of answers; and uploading, by a browser application, the vector to a server during a browsing session.

### FIELD

The present disclosure relates to browser applications and artificial intelligence (AI) models and, more particularly, to improved interactions between browser applications and client-side generative AI models.

### BACKGROUND

Existing web browsers may employ client-side generative AI models. Client-side models may generate responses and web browsers may use such responses.

In addition, websites may offer personalized AI services, such as personalized AI recommendations.

### BRIEF DESCRIPTION OF THE DRAWINGS

Reference will now be made, by way of example, to the accompanying drawings which show example embodiments of the present application, and in which:

FIG. 1 shows a schematic diagram illustrating an operating environment of an example embodiment according to the subject matter of the present application;

FIG. 2A shows a high-level schematic diagram of the computing systems of FIG. 1;

FIG. 3B shows a simplified organization of software modules stored in a memory of the example computing systems of FIG. 2;

FIG. 3 shows, in block diagram form, an example data facility of a computing device;

FIG. 4 is a block diagram illustrating a simplified example computing device in which methods and devices in accordance with the present description may be implemented;

FIG. 5 shows a flowchart of a simplified example method of generating a vector, according to an example embodiment;

FIG. 6 shows a flowchart of a simplified example method of uploading a vector and using the uploaded vector, according to an example embodiment;

FIG. 7 is an example graphical input interface in connection with uploading a vector and performing a search; and

FIG. 8 is a block diagram of a simplified transformer neural network, which may be used in examples of the present application.

Similar reference numerals may have been used in different figures to denote similar components.

### DETAILED DESCRIPTION OF EXAMPLE EMBODIMENTS

In one aspect, the present application describes a system. The system may include a communications module; one or more processors coupled to the communications module; and a memory coupled to the one or more processors. The memory may store instructions that, when executed by the system, cause the system to obtain user data and a set of defined queries; generate a set of answers to the set of defined queries, the generation including causing a model to create, based on the user data and the set of defined queries, the set of answers; use an embedding model to generate a vector based on the set of answers; and upload, by a browser application using the communications module, the vector to a server during a browsing session.

In some implementations, the vector may be based on embeddings of some or all of the answers.

In some implementations, the vector may be a vector of embeddings of some or all of the answers.

In some implementations, the user data may include sensor data.

In some implementations, the user data may include a browsing history of the browser application.

In some implementations, the user data may include data obtained from a third-party computer system.

In some implementations, at least a portion of the user data may be obtained based on a recency threshold.

In some implementations, the instructions, when executed by the computer system, may further cause the computer system to upload the vector to a plurality of computer systems.

In some implementations, the instructions, when executed by the computer system, may further cause the computer system to update a subset of answers in the set of answers; and update the vector based on the set of answers including the updated subset of answers.

In some implementations, the instructions may, when executed by the computer system, further cause the computer system to update the vector in response to an interaction between the browser application and a webpage.

In yet another aspect, the present application describes a computer-implemented notification method. The computer-implemented notification method may include obtaining user data and a set of defined queries; generating a set of answers to the set of defined queries, the generation including causing a model to create, based on the user data and the set of defined queries, the set of answers; using an embedding model to generate a vector based on the set of answers; and uploading, by a browser application, the vector to a server during a browsing session.

In some implementations, the method may further include uploading the vector to a plurality of computer systems.

In some implementations, the method may further include updating a subset of answers in the set of answers; and updating the vector based on the set of answers including the updated subset of answers.

In yet another aspect, present application describes a non-transitory computer-readable storage medium storing processor-executable instructions which, when executed, may cause a processor and/or computer system to obtain user data and a set of defined queries; generate a set of answers to the set of defined queries, the generation including causing a model to create, based on the user data and the set of defined queries, the set of answers; use an embedding model to generate a vector based on the set of answers; and upload, by a browser application, the vector to a server during a browsing session.

In yet a further aspect, the present application describes a non-transitory computer-readable storage medium storing processor-readable instructions that, when executed, configure one or more processors to perform any of the methods described herein. Also described in the present application is a computing device comprising: one or more processors, memory, and an application containing processor-executable instructions that, when executed, cause the one or more processors to carry out at least one of the methods described herein. In this respect, the term processor is intended to include all types of processing circuits or chips capable of executing program instructions.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of …or…” is intended to cover any one or more of the listed elements, including any one of the listed elements alone, any sub-combination, or all of the elements, without necessarily excluding any additional elements, and without necessarily requiring all of the elements.

In the present application, reference may be made to the term “vector”. A vector may refer to an array of numbers in n-dimensional space. A vector may also be used to refer to an array of an array of numbers in n-dimensional space.

In the present application, reference may be made to the term “embedding”. An embedding may refer to a numerical representation of data that captures relevant qualities of the data in a manner that machine learning algorithms may process. An embedding that takes the form of a vector may be referred to as a “vector embedding”.

In the present application, reference may be made to the terms “near-term” and “near-term data”. In at least some embodiments, near-time is defined as being within days or months. For example, the near-term may be three days or three months. Near-term data may refer to data created and/or collected within the near-term.

In the present application, the term generative AI model may be used to describe a machine learning model (MLM). A generative AI model may sometime be referred to, or may use, a language learning model or LLM. A trained generative AI model, e.g. an LLM, may respond to an input prompt by generating and producing an output or result. The output or result may be generated by the generative AI model through interpreting the intent and context of the prompt. In some cases, the generative AI model may be implemented with constraints on the acceptable prompts.

Existing web browsers may employ client-side generative AI models. The use of client-side generative AI models introduces performance challenges since these models require substantial computational resources and training time. Moreover, client-side models may have access to user data and generate responses that include the user data. Web browsers may upload such responses to a web server, which can also raise privacy concerns.

In addition, websites may offer personalized AI services, such as personalized AI recommendations. Approaches for offering personalized AI services typically depend on large language models that require users to upload large amounts of personal data. This introduces performance challenges, since uploading and processing large datasets requires significant computing resources.

It would be advantageous to provide for systems and methods that improve client-side interactions with generative AI models, and facilitate offering personalized AI services, in a manner that meets a certain level of privacy and is lightweight.

To better illustrate additional details regarding the methods and systems of the present application some concepts relevant to generative AI models, neural networks, and machine learning (ML), are first discussed.

Generally, a neural network includes a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model’s accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publically-available text corpuses may be, e.g., fine-tuned by further training using the complete works of Shakespeare as training data samples (e.g., where the intended use of the ML model is generating a scene of a play or other textual content in the style of Shakespeare).

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

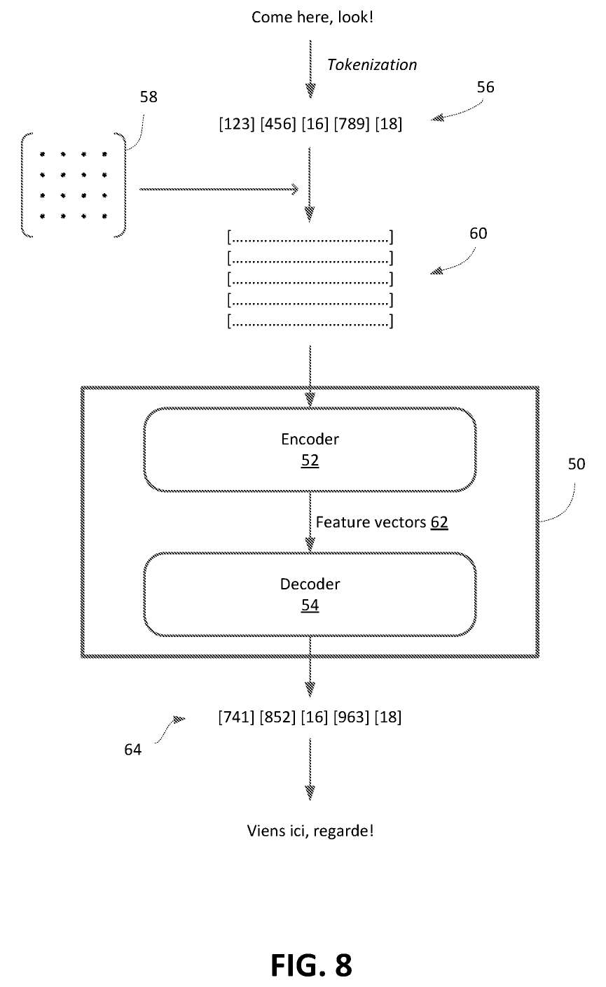

FIG. 8 is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabelled. LLMs may be trained on a large unlabelled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 8, a short sequence of tokens 56 corresponding to the text sequence “Come here, look!” is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 8 for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

A computing system may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

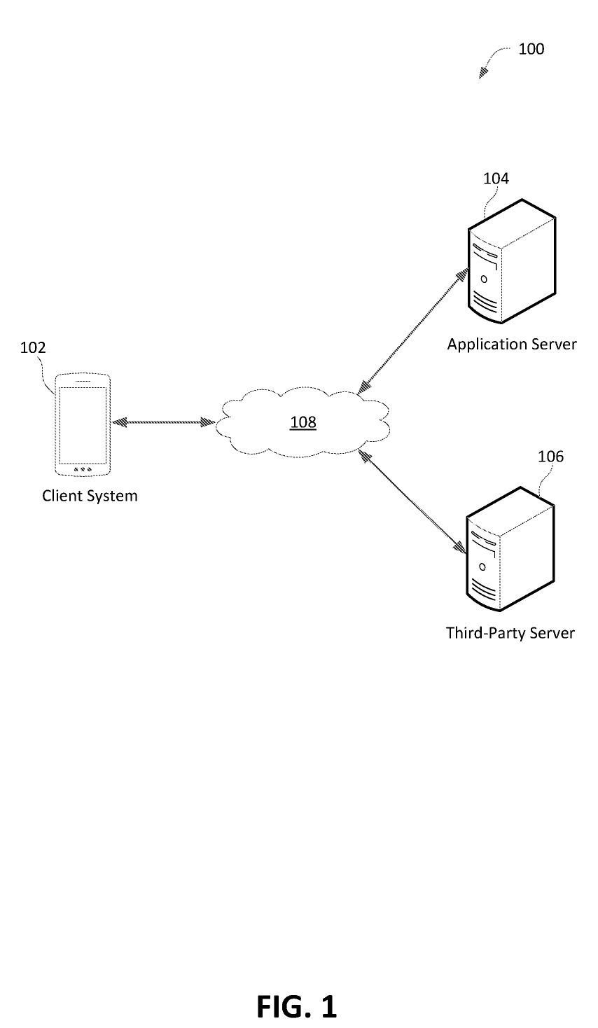

Reference will now be made to FIG. 1, which diagrammatically illustrates an operating environment 100 in which methods and devices in accordance with the present description may be implemented. The environment 100 includes in this example includes a client system 102, a application server 104, and a third-party server 106.

Although the client system 102, application server 104 and third-party server 106 are depicted as being implemented by particular devices such as a smartphone and a desktop computer, it will be understood that the client system 102 and servers 104, 106 may be implemented by one or more computing devices, including servers, personal computers, tablets, smartphones, Internet of Things (IoT) devices, or any other type of computing device that may be configured to store data and software instructions and execute software instructions to perform operations consistent with disclosed embodiments.

The client system 102 may be configured to execute one or more software applications. A software application may be a client application configured access or interact with online services or resources. A client application may include a web browser application, email application, messaging application, file transfer programs, remote desktop software, or other type of application that connects to the Internet to access specific services or data. A client application may run internal or external to a web browser. The client application may be an interactive application that a user may interact with, for example, via an input interface.

In some embodiments, a software application may be executed, in whole or in part, or at least in part, by the client system 102 and may be provided to the client system 102 via an application server 104. For example, an application may be provided to the client system 102 by the application server 104 as a web-based or cloud-based application. The client system 102 may execute a client-side portion of the web-based or cloud-based application within a browser application (e.g. such that a storefront of an e-commerce store may be provided to the user via the browser). The application server 104 may be referred to as a web application server and execute a server-side portion of the web-based or cloud-based application.

In some embodiments, the operations of the application server 104 may be provided as a cloud computing service, a software as a service (SaaS), and the like. The application server 104 may execute aspects of an application or service for the client system 102. The application server 104 may be capable of receiving requests from the client system 102 and serve content in response to those requests. The content may include, for example, text, graphics, audio, and/or video. The content may be served in the form of HyperText Markup Language (HTML), Extensible Markup Language (XML), Cascading Style Sheets (CSS), WebAssembly (Wasm), JavaScript™ Object Notation (JSON), JavaScript™, and/or another client-side structured language.

The application server 104 may provide a front-end interface that facilitates interactions between the client system 102 and the application server 104. For example, the application server 104 may provide one or more graphical user interfaces (GUIs) to the client system 102. The user interface may be capable of triggering the application server 104 to perform a search and provide personalized data during a browsing session.

The third-party server 106 may store and maintain data regarding users or customers associated with the third-party server 106. The data may be for one or more user accounts. A user account may correspond to a user of the client system 102. Each account may include a record that may be or represent account data or other data maintained by the third-party server 106. The record may include data of various types and the nature of the data may depend on the nature of the third-party server 106. By way of example, in some implementations, the record may include, for example, documents and/or other data stored by or on behalf of a user.

The third-party server 106 may be configured to verify authentication information received from the client system 102 as corresponding to one or more accounts and/or authentication data maintained by the third-party server 106.

As illustrated, the client system 102 is in communication with the application server 104 and the third-party server 106 via the network 108. The client system 102, application server 104 and the third-party server 106 may be configured to transmit and receive messages between each other.

The client system 102 may be configured to ingest data from the third-party server 106. The client system 102 and application server 104 may be configured to ingest data and transmit requests, replies, alerts, notifications, configuration objects, or other data to each other.

The client system 102 may be a computing device and may, as illustrated, be a smart phone. However, the client system 102 may be a computing device of another type such as, for example, a mobile device, a desktop computer, a laptop computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments.

The third-party server 106 may be or include a computer system such as a database management system, resource management systems, or data transfer systems. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, web servers, email servers, file transfer protocol (FTP) servers, compute servers, and the like.

The client system 102, application server 104, and third-party server 106 may be in geographically disparate locations.

The network 108 is a computer network. The network 108 may be an internetwork such as may be formed of one or more interconnected computer networks. For example, such a network may be or may include an Ethernet network, an asynchronous transfer mode (ATM) network, or a wireless network. In some implementations, the network 108 may be the Internet. One example of a wireless network is a cellular network. Another example of a wireless network is a close proximity (i.e. personal area) wireless network, sometimes referred to as a wireless personal area network (WPAN). Examples of WPANs include Bluetooth™ and Zigbee™. The network 130 may facilitate communication between the client system 102, application server 104, and third-party server 106.

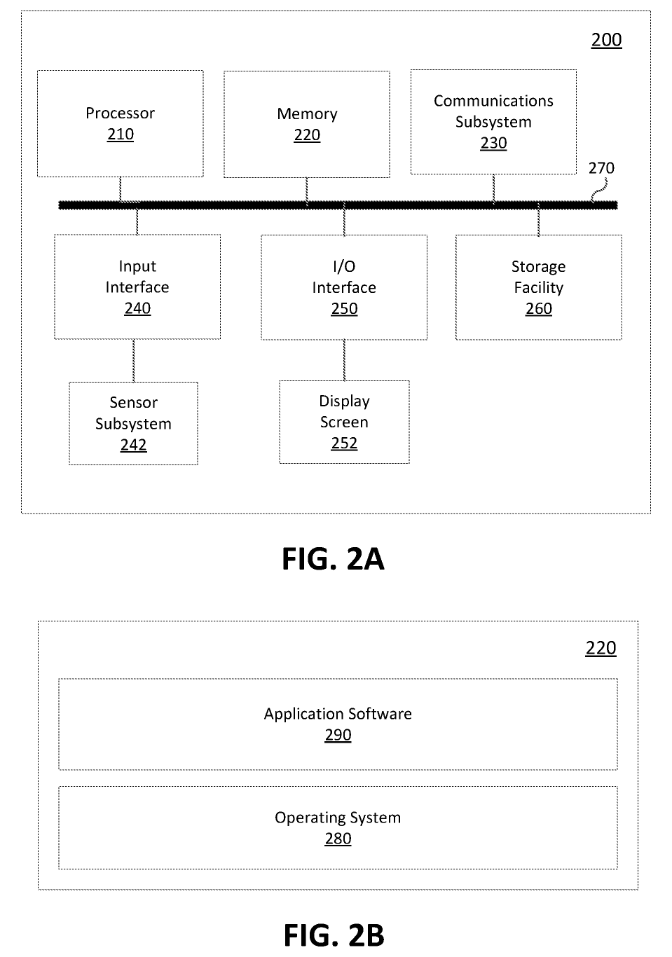

FIG. 2A is a high-level schematic diagram of an example computing device 200. In some embodiments, the example computing device 200 may be exemplary of the client system 102, application server 104, and third-party server 106 in the example operating environment 100 of FIG. 1.

The example computing device 200 includes a processor 210, a memory 220, a communications subsystem 230, an input interface 240, a sensor subsystem 242, an output interface 250, a display screen 252, and a storage facility 260. As illustrated, the foregoing example elements of the example computing device 200 are in communication over a bus 270.

The processor 210 is a hardware processor. The processor 210 may, for example, be one or more ARM, Intel x86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computing device 200.

The communications subsystem 230 allows the example computing device 200 to communicate with other computing devices and/or various communications networks. For example, the communications subsystem 230 may allow the example computing device 200 to send or receive communications signals. Communications signals may be sent or received according to one or more protocols or according to one or more standards. For example, the communications subsystem 230 may allow the example computing device 200 to communicate via one or more wireless networks, such as for example, a cellular wireless network, according to one or more standards such as, for example, Global System for Mobile Communications (GSM), Code Division Multiple Access (CDMA), Evolution Data Optimized (EVDO), Long-term Evolution (LTE), or 5G. Additionally or alternatively, the communications subsystem 230 may allow the example computing device 200 to communicate via a wireless personal area network (WPAN) via some combination of one or more networks or protocols such as, for example, Bluetooth™ and Zigbee™. In some embodiments, all or a portion of the communications subsystem 230 may be integrated into a component of the example computing device 200. For example, the communications subsystem 230 may be integrated into a communications chipset or circuit. In some embodiments, the communications subsystem 230 may be or include a network adapter, which may be wired or wireless. In some embodiments, the communications subsystem 230 may be referred to as a communications module.

The input interface 240 allows the example computing device 200 to receive input signals. Input signals may, for example, correspond to input received from a user. The input interface 240 may serve to interconnect the example computing device 200 with one or more input devices. Input signals may be received from input devices by the input interface 240. Input devices may, for example, include one or more of a touchscreen input, keyboard, trackball or the like. In some embodiments, all or a portion of the input interface 240 may be integrated with an input device. For example, the input interface 240 may be integrated with one of the aforementioned examples of input devices.

The input interface 240 may receive input from a sensor subsystem 242 that may be a sensor that gathers and generates sensor data based on a sensed condition. By way of example, the sensor subsystem 242 may be or include a location, camera and/or health subsystem.

The location subsystem may that generate location data. The location data may define a location, which may be the current geographic location of the computing device 200. In some embodiments, the sensor subsystem 242 may generate location events, such as when the computing device 200 enters or leaves a region.

The location subsystem may utilize and may include or may interact with a receiver of one or more of satellite-based location systems, such as, for example, global positioning satellite (GPS), GLONASS, BeiDou Navigation Satellite System (BDS), and/or Galileo in order to locate the computing device 200. Additionally or alternatively, the location subsystem may employ other techniques/technologies for location determination such as, for example, an inertial navigation system (INS), a wireless (e.g., cellular, Wi-Fi™) triangulation system, use of wireless (e.g., Wi-Fi™) hotspot location data, a beacon-based location system (such as a Bluetooth™ low energy beacon system), and/or a location subsystem of another type. In some embodiments, the location subsystem may be included in the communications subsystem 230 such as, for example, where cell-tower triangulation and/or wireless hotspot location data is employed in determining location.

The camera subsystem may be configured to generate camera data, such as images in the form of still photographs and/or video data. The camera data may be captured in the form of an electronic signal that is produced by an image sensor included in or associated with the camera subsystem. More particularly, the image sensor may be configured to produce an electronic signal in dependence on received light. The image sensor may convert an optical image into an electronic signal, which may be output from the image sensor by way of one or more electrical connectors associated with the image sensor. The electronic signal represents electronic image data, which may be referred to as camera data.

The health subsystem may be configured to generate human health data. Health data may include user health and fitness data and, more particularly, heart rate details. The health data may be captured in the form of an electronic signal that is produced by a heart rate sensor included in or associated with the health subsystem. More particularly, the heart rate sensor may be configured to produce an electronic signal in dependence on a user’s pulse. The heart rate sensor may measure pulse waves and convert the measurements into an electronic signal, which may be output from the heart rate sensor by way of one or more electrical connectors associated with the heart rate sensor. The electronic signal represents electronic image data, which may be referred to as health data. In some embodiments, the heart rate sensor may be a heart rate monitor and continuously monitor a heart rate.

The output interface 250 allows the example computing device 200 to provide output signals. Some output signals may, for example allow provision of output to a user. The output interface 250 may serve to interconnect the example computing device 200 with one or more output devices. Output signals may be sent to output devices by output interface 250. Output devices may include, for example, a display screen 252 such as, for example, a liquid crystal display (LCD), a touchscreen display. Additionally, or alternatively, output devices may include devices other than screens such as, for example, a speaker, indicator lamps (such as, for example, light-emitting diodes (LEDs)), and printers. In some embodiments, all or a portion of the output interface 250 may be integrated with an output device. For example, the output interface 250 may be integrated with one of the aforementioned example output devices.

The storage facility 260 allows the example computing device 200 to store and retrieve data and, in some embodiments, may be referred to as a data store. In some embodiments, the storage facility 260 may be formed as a part of the memory 220 and/or may be used to access all or a portion of the memory 220. Additionally or alternatively, the storage facility 260 may be used to store and retrieve data from persisted storage other than the persisted storage (if any) accessible via the memory 220. In some embodiments, the storage facility 260 may be used to store and retrieve data in/from a database. A database may be stored in persisted storage. Additionally or alternatively, the storage facility 260 may access data stored remotely such as, for example, as may be accessed using a local area network (LAN), wide area network (WAN), personal area network (PAN), and/or a storage area network (SAN). In some embodiments, the storage facility 260 may access data stored remotely using the communications subsystem 230. In some embodiments, the storage facility 260 may be omitted and its function may be performed by the memory 220 and/or by the processor 210 in concert with the communications subsystem 230 such as, for example, if data is stored remotely. The storage facility 260 is illustrated as a single unit for ease of illustration, but may include a plurality of storage units.

Software comprising instructions is executed by the processor 210 from a computer-readable medium. For example, software may be loaded into random-access memory from persistent storage of the memory 220. Additionally or alternatively, instructions may be executed by the processor 210 directly from read-only memory of the memory 220.

FIG. 2B depicts a simplified organization of software modules stored in the memory 220 of the example computing device 200. As illustrated, these software components include an operating system 280 and application software 290.

The operating system 280 is software. The operating system 280 allows the application software 290 to access the processor 210, the memory 220, the communications subsystem 230, the input interface 240, the sensor subsystem 242, the output interface 250, the display screen 252, and the storage facility 260 of the example computing device 200. The operating system 280 may be, for example, Google™ Android™, Apple™ iOS™, UNIX™, Linux™, Microsoft™ Windows™, Apple OSX™, Linux™ distribution, or the like.

The application software 290 adapts the example computing device 200, in combination with the operating system 280, to operate as a device performing particular functions.

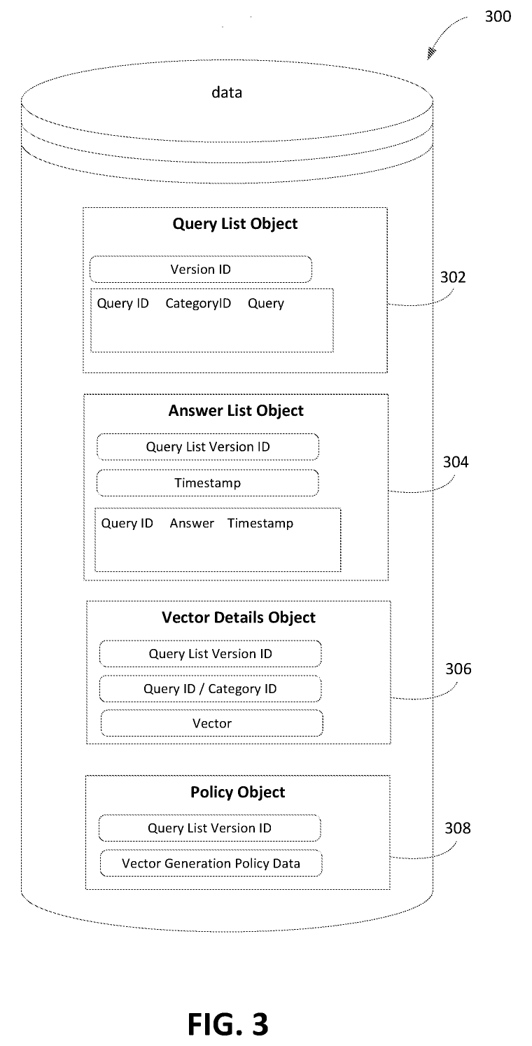

Reference is now made to FIG. 3, which partially illustrates an example data facility 300 in block diagram form. The data facility may be a data facility of the client system 102 of FIG. 1. Not all components of the data facility 300 are illustrated. The data facility 300 may include one or more data storage units. In some cases, the stored data may be in a database format and may include one or more databases. The databases may be relational databases in some examples. The data facility 300 is illustrated as a single use for ease of illustration, but may include a plurality of storage units. The data store may store data in various objects, each of which may be a data structure.

The data facility 300 may store data regarding a list of defined queries in a query list object 302. The query list object 302 may include a version identifier and query details.

The version identifier may indicate the version of the list of defined queries. The defined questions may change over time, resulting in different versions of the set of defined questions.

The query details may include one or more queries. A query may be identified by a query identifier. A query may be a request for information. The query may be in the form of a question or a command. In some cases, a query may be constructed so that it may be considered safe and may not result in a response that contains information that should not be shared with a server. A query may be directed to user preferences or tastes and may require binary (e.g. yes/no) answers. Example queries may be in the nature of: “between a suit jacket and a winter jacket, which one would you be more interested in buying?”; “what is your favorite tie color?”; “tell me whether a restaurant review is something you would click on to learn more about”; “what have you been looking at recently?”, and the like. In some embodiments, a query may specify a time constraint. For example, a query may specify that the query is to be evaluated based on events occurring in the near-term.

The list of defined queries may be associated with a set of defined categories of queries. Each query in the list of defined queries may belong to a particular defined category, which may be identified by a corresponding category identifier. One or more queries may be assigned to the same category.

A category may correspond to particular preferences of a user of a client device. Examples of categories include clothing or fashion preferences, transportation preferences, and food preferences. In some embodiments, the first two example queries may correspond to the clothing or fashion preferences and the third example query may correspond to a food preferences category. The fourth example query may not be assigned to a user activity category.

A model may generate an output in response to an input query. The output may be referred to as an answer to the query. The data facility 300 may store data regarding a list of answers to a list of defined queries in an answer list object 304. The answer list object 304 may include a query list version identifier, timestamp, and response details. The query list version identifier may link to a query list object 302. The timestamp may, for example, indicate when the list of answers was generated or last updated. The answer details may include a answer for each query in the list of defined queries. The list of answers may include a respective answer to each particular query in the list of defined queries. Example answers to the above example queries may be in the nature of: “My primary focus is on suit jackets, not winter jackets. I often wear well-tailored, classic cut suits.”; “I have a preference for blue ties in either pale blue or navy shades, but I also own and wear red and yellow ties.”; “A restaurant review would likely be of interest to me if it’s about a local establishment.”; “I have recently been engaged in watching Thanksgiving-themed children’s movies.”, and the like. The answer details may also include a timestamp indicating when the particular response was generated or last updated.

The data facility 300 may store data regarding a vector in a vector details object 306. The vector details object 306 may include a query list version identifier, a query or category identifier, and a vector. The query list version identifier may link to a query list object 302. In cases where the vector corresponds to a particular query or query category, the query list object 302 may include a query or category identifier.

The data facility 300 may store data regarding a policy in a policy object 308. A policy may refer to a data structure or other information that includes a set of preferences, rules, conditions or other criteria for controlling access to user data, generating a vector, and for defining the behavior of operations of a client device or a component or function thereon. The policy may be used to provide query specific, category specific, and/or query list specific policy data that is customizable on a query, category and/or query list basis.

The policy may include an enterprise defined policy and/or a user defined policy. A user may configure a policy to prevent the sharing of information derived or generated from user data. In some embodiments, the policy may be configured, for example, by a user via a user interface provided by a client device or browser application that facilitates setting privacy and security controls. In some embodiments, an opt out or opt in mechanism may be provided that allows a user to control whether a particular query or category of queries is allowed to be input to a client-side model as a prompt; whether a particular query or category of queries is allowed to be answered using on the user data; and/or whether a particular query or category of queries is to be answered in a completely neutral way.

In cases where a policy corresponds to a particular version of a list of defined queries, the policy object 308 may include an identifier of a version of a query list that the policy object corresponds to.

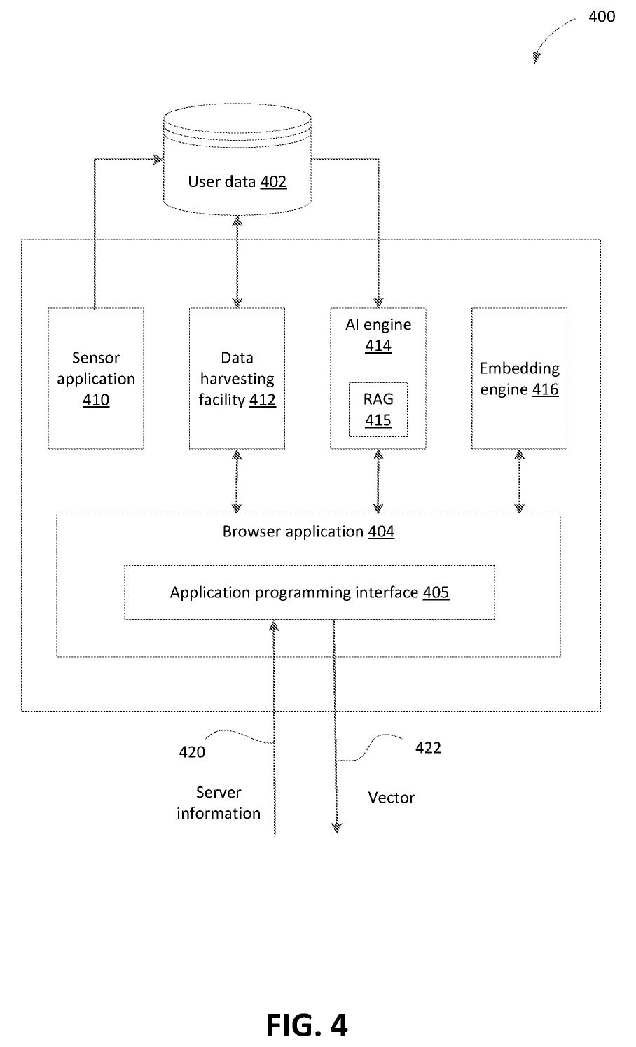

Reference is now also made to FIG. 4, which illustrates a simplified example computing device 400 in which methods and devices in accordance with the present description may be implemented. The computing device 400, in some examples, may be configured to generate a vector and upload the vector to a server. The computing device 400 be or include the client system 102 in the example operating environment 100 described in FIG. 1.

The computing device 400 may, in some instances, include a sensor application 410 for collecting or capturing data using sensors included in or connected to the computing device 400.

In one example, the sensor application 410 includes a camera application for using a camera subsystem to capture one or more forms of digital media including images, videos and/or sound. Another specific example of a sensor application 410 may be a location application to capture location information of the computing device. Another example includes a health application that helps a user to track their health and fitness to improve their overall well-being. The health application may track a variety of activities, including walking, running, and sleeping. The application may provide insights into sleep time, sleep stages, and body movement.

The information gathered by the sensor application 410 may be stored in a raw or processed form, as user data 402. For example, the computing device may store raw geographical location data in latitudinal or longitudinal form, or may process the raw data and store the processed data. For example, raw geographical location data may be processed to determine a municipal address, which may be stored by the computing device.

The computing device 400 may, in some instances, include a data harvesting facility 412 configured to perform harvesting activities to collect user data from a variety of sources, including disparate and distributed sources. The data harvesting facility 412 may be configurable to collect user-specific, device-specific, or system-wide information. The term user-specific information may refer to information that corresponds to a particular user of the client device. The term device-specific information may refer to information that corresponds to the client device and is not restricted to a particular user. The term system-wide information may refer to information which is not restricted to the client device.

The data harvesting facility 412 may perform an initial full harvest. In a full harvest, the data harvesting application may collect data including a set of data items. The collected data may be stored as user data 402 along with metadata for each data item in the set of data items. The metadata may include a timestamp indicating a date and time of the collection of the data item. The metadata may also include a location identifier indicating a location from which the data was retrieved. The location identifier may be a uniform resource identifier (URI) that identifies a resource locally on the computing device 400 or on a remote server.

To maintain the timeliness, accuracy, and consistency of the user data repository, the data harvesting facility 412 may perform subsequent re-harvests. To speed up subsequent harvests, an incremental harvest may be performed to only harvest for data that has changed or is new. Because the harvest is incremental, it may take less time to update the user data repository and may incur a lighter load on the computing device 400 than the original full harvest. An incremental harvest may fetch new data that was created since the last harvest and/or delete data that was removed since the last harvest. In some cases, a full re-harvest may be performed.

The computing device 400 includes a machine learning or artificial intelligence engine 414. The artificial intelligence engine 414 may include a generative artificial intelligence model that is trained on public data. The public data may exclude the user data 402. The knowledge of the model may have a cutoff date, which may be the date at which the data used to train the model was gathered.

The artificial intelligence engine 414 may be capable of receiving and using user data 402 to form responses to queries input to the model. The user data 402 may include data created and collected after the knowledge cutoff date of the model.

In some embodiments, the artificial intelligence engine 414 is configured to include a Retrieval Augmented Generation (RAG) layer 415 that uses a vector database populated with vectors based on or generated from the user data 402. The vector database may be used to generate relevant context from the user data 402 for input to the model. In some embodiments, the artificial intelligence engine 414 may use the user data 402 to fine-tune the model.

The artificial intelligence engine 414 may, as illustrated, be local to the computing device 400. The model may be a local model that is integrated into the browser application, or installed in the browser application as a plugin. It may also be a system-wide service that may, for example, be part of the operating system of the computing device 400. However, in some cases, the artificial intelligence engine 414 may be remote from the computing device 400 and may reside on a server within the client system 102 of the example operating environment 100 of FIG. 1. The model may be trained, managed, owned or operated by a third-party. In some embodiments, the model may reside on a third-party server. The artificial intelligence engine 414 may transmit the output of the model to the browser application 404.

The computing device 400 includes an embedding engine 416 capable of receiving a response output by a model included in the AI engine 414. The embedding engine 416 may apply an embedding model to the response to generate a vector. The embedding model may use any suitable technique for obtaining a vector representation of the input. An example technique is word2vec, which is a technique in natural language processing (NLP) for converting words into vectors that represent their meaning, context, and relationships with other words.

The computing device 400 includes a browser application 404 capable of receiving information 420 from a server. The information may include a script, code or other computer-executable instructions for execution by the computing device 400. The instructions may invoke an application programming interface 405 included in the browser application 404 and cause the browser application 404 to perform one or more operations described in the present application. In some embodiments, the application programming interface 405 may be used to generate, update, and/or retrieve a vector 422. The browser application 404 may transmit the vector 422 to the server.

The application programming interface 405 may be configured to receive application programming interface requests. The application programming interface 405 may perform operations to service the application programming interface requests. The application programming interface requests may define parameters. The parameters may be included in information 420 received from the server. Example parameters include a query list version identifier, one or more query identifiers, and/or one or more category identifiers. The information 420 may, for example, specify a query identifier to retrieve and receive a query-specific, or specify a category identifier to retrieve and receive a category-specific vector, and may specify a version identifier to receive a vector corresponding to the identifier version of the query list.

The browser application 404 may interact with the data harvesting facility 412 by triggering the data harvesting facility 412 to collect or update the user data 402.

The browser application 404 may also interact with the artificial intelligence engine 414 by providing the artificial intelligence engine 414 with the user data 402 to enhance the responses output by the model, and by inputting a list of queries to the model to generate a list of answers. The artificial intelligence engine 414 may transmit the list of generated answers to the browser application 404.

The browser application 404 may also interact with the embedding engine 416 by providing the list of generated answers as input to the embedding model to generate a vector. The embedding engine 416 may transmit the vector to the browser application 404.

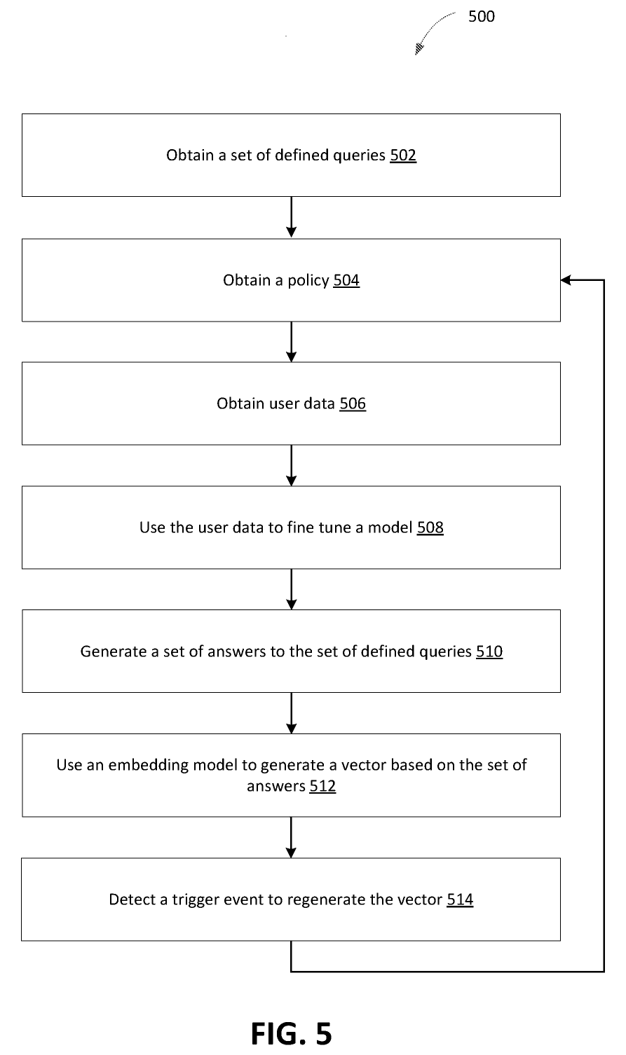

Reference will now be made to FIG. 5, which illustrates an example method 500 for generating and updating a vector. The method 500 may be implemented by one or more computer systems suitably programmed to carry out the functions described. The operations of the example method 500 may be performed by one or more computer systems which may be of the type described herein. In some embodiments, one or more of the operations may be carried out by the client system 102 in the example operating environment 100 described in FIG. 1. In this example, the client system 102 may be referred to as a computing device. In some embodiments, aspects of one or more operations of the method 500 may be carried out by a software application installed on the computing device. The software application may be a browser application. The client device may be configured to communicate with a data facility 300 of FIG. 3 and receive or respond to communications from a server.

The method 500 may be triggered or initiated on a computing device during installation or update of a browser application on the computing device, or may be triggered or initiated in some other manner. In some cases, the vector may be generated before the browser application interacts with a particular webpage, website or web application. However, in some cases, the generation of the vector may be triggered by an interaction between the browser application and a particular webpage, website or web application. The interaction may include a visit to a webpage or website and/or establishing a connection with a particular server. For example, a webpage may be configured to invoke, via the browser application, an application programming interface that initiates the generation of the vector.

In operation 502, the computing device may obtain a set of defined queries. The set of defined queries may, for example, be obtained from memory or a remote trusted server. The computing device may be configured to restrict a website or web application to using the set of defined queries to query a client-side model. The set of defined queries may be stored in a query list object 302 of the data facility 300 of FIG. 3.

In operation 504, the computing device obtains a policy. The policy may indicate a respective status of one or more queries in the set of defined queries, as well as a respective status of one or more categories corresponding to the set of defined queries. The status may be, for example, either “enabled” or “disabled”. The status may be based on input received by the computing device, via a policy settings graphic user interface or other interface, indicating a selection of a status of a defined query or category. The generation of the vector may be based on the policy and the statuses of the queries and categories.

In operation 506, the computing device obtains user data. The user data may be collected from one or more local sources residing on the computing device and/or from one or more remote sources. A local source may include, for example, a user directory and a remote source may include, for example, a social media server storing data associated with a user of the computing device.

The computing device may perform an initial harvesting activity to collect the user data. The harvesting activity may be based on the policy, which may include settings for performing the harvesting activity. For example, the policy may indicate one or more sources from which to collect the user data. For example, the policy may include a list of remote third-party computer systems as well as corresponding credentials that may be provided to the remote systems to retrieve data from the remote systems.

In some embodiments, the user data may be or include user-specific data corresponding to a particular user of the client device. The user data may also be or include device-specific data and may not correspond to an individual person.

User data may include, for example, any one or more of: browsing history; clickstream data; social media data; sensor data; digital media including images, videos and/or sound; user email stored locally or on a remote mail server; user purchase history stored locally or on a remote e-commerce server; financial transaction history; electronic documents; invoices, payment receipts, digital identity data such as stored identity information or documentation; photographs, text-based documents, user preferences, or other types of documents and/or data. User data may also include personal data, personally identifiable data, sensitive data, public data, private data, and/or ordinary data.

Browsing history may include a list of webpages visited by the browser application, as well as associated metadata such as page title and time of visit.

Clickstream data may include details of a user’s interactions with a website or web application as represented by a sequence of links they click on. Example details may include the number of click events, types of click events, number of webpage views, and time spent on each webpage.

Social media data may be information gathered from social media platforms and may indicate how users engage with content and profiles on social media platforms. Social media data may include details regarding interactions, content, connections, ratings and interests. Example interactions include shares, likes comments, mentions, clicks and replies. Examples of content include visual content, photos, videos and the content of user posts. Example connection details include details regarding network connections between users, friend connections and connections with groups.

Sensor data may include information collected from the client device’s environment using, for example, a location sensor or image sensor. Sensor data may also include data collected by a user health sensor, such as, for example, a heart rate monitor.

User data may be or include near-term data. The near-term user data may be used to improve the timeliness and accuracy of the output of a model by providing a near-term context for forming the model responses.

In some embodiments, at least a portion of the user data may be near-term data and obtained based on a recency threshold. The recency threshold may be specified by the policy and may be defined, for example, in days or months. Data that is older than the recency threshold may not be collected and may be excluded from the user data. For example, the computing device may only collect data items that have a creation date within the recency threshold.

The user data may be used to form responses generated by a model. However, retraining the model may require a significant investment in computational resources and training time. Accordingly, in some embodiments, the user data may be used to form responses without retraining the model. In operation 506, one or more other techniques may be implemented to enhance model responses based on the user data.

One example technique is fine-tuning of a pretrained model on a small amount of user data. Example fine-tuning algorithms may include Low-Rank Adaptation (LoRA) and Quantized Low-Rank Adaptation (QLoRA), or other Parameter-Efficient Fine-Tuning (PEFT) methods.

Another example technique is Retrieval Augmented Generation (RAG). RAG leverages external knowledge sources, which may include the user data or be based on the user data, to enhance the generation process by retrieving relevant information and feeding it to the model together with the prompt or query. Through this approach, relevant chunks of domain-specific information may be retrieved and sent to the model for context-aware response generation. In other words, an information retrieval system is used to obtain relevant domain-specific data and that relevant domain-specific data is used to augment the prompt that is then used by the model to generate the requested response.

Yet another example technique includes providing the user data as contextual information through a prompt that is used by the model to generate the requested response.

In cases where the model is hosted on a remote computer system, the client device may facilitate enhancement of the model responses by providing the remote computer system with the user data and sending a message to the remote computer system to trigger the remote computer system to implement one or more techniques for enhancing responses of the model based on the user data.

In operation 510, the computing device generates a set of answers to the set of defined queries. The generation may include causing the model to create, based on the user data and the set of defined queries, the set of answers.

The set of answers may be created by inputting the set of defined queries into the model as prompts. A respective prompt may be input into the model for each particular query in the set of defined queries. The model may output a respective answer for each particular query in the input set of defined queries.

In some embodiments, the generation of the set of answers may be based on the policy. By way of example, the policy may indicate whether a whether a particular query or category of queries is allowed to be input to the client-side model as a prompt. The computing device may use this information to identify a subset of queries in the set of defined queries that are to be input into the client-side. The computing device may input only the subset of defined queries into the model to generate a set of answers. Individual queries, or entire categories of queries, may be filtered out and excluded from being input into the client-side model.

By way of another example, the policy may indicate whether a particular query or category of queries is allowed to be answered based on the user data. The computing device may use this information to identify a first subset of queries in the set of defined queries that are to be answered based on the user data. The computing device may input the first subset of defined queries into the model and use the user data to form a first set of answers generated by the model.

The computing device may also identify, based on the policy, a second subset of queries in the set of defined queries that are not allowed to be answered based on the user data. In other words, the second subset of queries is to be answered without being based on the user data. In this case, the computing device may, without implementing one or more techniques to enhance model responses based on the user data, input the second first subset of defined queries into the model and generate a second set of answers. The first and second sets of answers may then be combined into a single set of answers.

By way of yet another example, the policy may indicate whether a particular query or category of queries is to be answered in a neutral way. The computing device may use this information to identify a subset of queries in the set of defined queries that are to be answered in a neutral way. An answer to a query may be generated by providing a prompt that includes a command to the model to generate the answer to the query in a neutral way. For example, a neutral answer to a yes or no question may be “maybe” or “perhaps”. In this way, a set of neutral answers may be generated to the identified subset of queries.

The various sets of answers to the subsets of defined queries may be stored in a single answer list object 304 of the data facility 300 of FIG. 3.

In operation 510, the computing device may use an embedding model to generate a vector based on the set of answers. More particularly, the computing device may provide the set of answers as input to the embedding model to generate the vector. The vector may be based on embeddings of some or all of the answers, and the vector may be a vector of embeddings of some or all of the answers. Various techniques may be implemented to generate the vector based on the set of answers.

In a first technique, the embedding model may be applied to each particular answer in the set of answers to create a vector of one or more embeddings. The vector of one or more embeddings may sometimes be referred to as an “embedding vector”, where each embedding may itself be a vector of, for example, real numbers.

In another technique, the set of answers may be combined with each other or concatenated to create a single answer. The single answer may be embedded into a single vector by inputting the single answer into the embedding model to generate the vector.

In some embodiments, the computing device may generate a “general” vector and/or one or more category-specific vectors. For example, a “fashion preference” vector and/or a “food preference” vector may be created. The general vector may be a vector that is created using the entire set of answers. A category-specific vector may be a vector that is created using a subset of answers in the set of answers that correspond to a particular category of queries. A category-specific vector may correspond to a particular category in a plurality of defined categories of queries.

There may be different versions of the set of defined queries (which may change over time) and, accordingly, there may be different versions of a vector depending on which version of the set of defined queries the vector is based on. The computing device and browser application may maintain, store and cache different versions of a vector that correspond to different versions of the set of defined queries.

The vector may be based on the user data and the set of answers, but may not directly include any of the user data and/or set of answers. The vector may exclude all of the content of the user data and/or set of answers. By way of example, the user data and/or set of answers may include content such as, for example, text, image, audio, or video data, but the vector may exclude the text, image, audio, or video data, and the underlying words or pixels.

In some embodiments, the policy may be applied at the vector generation stage in operation 510 instead of, or in addition to, the answer generation stage in operation 508. The computing device may determine, based on the policy, whether a particular query or category is disabled. In response to determining that a particular query or category is disabled, the computing device may skip operations for generating a corresponding answer, or the generated answer may be substituted with a null answer or a defined answer. The null answer or defined answer may be used when generating the vector.

The vector may be updated in response to various events. In operation 512, the computing device may detect a trigger event to regenerate or update the vector, the set of answers, or a subset of answers in the set of answers.

In some embodiments, the trigger event may include an interaction between the browser application and a webpage. The interaction may include a visit to a webpage or website and/or establishing a connection with a particular server. For example, a webpage may be configured to invoke, via the browser application, an application programming interface that initiates the regeneration of the vector. In this way, the browser application may receive, via a webpage provided by the server, an instruction from the server to update the vector.

In some embodiments, the trigger event may include a determination that the vector is outdated. More particularly, the vector may have a corresponding creation date timestamp that is tracked by the computing device. When a webpage or browser application retrieves a generated vector, the computing device may determine whether the vector is stale. The determination may be made based on a policy defining a recency threshold. If the vector is older than the threshold, the computing device may regenerate the vector.

In some embodiments, the trigger event may include a determination that an answer upon which the vector is based is outdated. More particularly, each answer may have a corresponding creation date timestamp that is tracked by the computing device. When a webpage or browser application retrieves a generated vector, the computing device may determine whether an answer upon which the vector is based is stale. The determination may be made based on a policy defining a recency threshold. If the answer is older than the threshold, the computing device may regenerate the stale answer. To regenerate the vector, the only the stale answer may be regenerated. The remaining answers can be retrieved from, for example, the answer list object 304 in the data facility 300 of FIG. 3.

In some embodiments, the trigger event may include a detection of new user data becoming available. For example, a data harvesting facility may continuously monitor one or more data sources and detect new user data at one of the data sources.

In response to detecting the trigger event, the computing device may perform one or more operations to regenerate the vector. It will be appreciated that the operations 504, 506, 508, 510, 512 of the method 500 may be modified to regenerate the vector. For example, in operation 506, an incremental harvest may be performed rather than a full re-harvest. Those skilled in the art may recognize that other variations may be necessary.

In some embodiments, the vector may be deleted upon receiving user input indicating an instruction to clear a browser application cache.

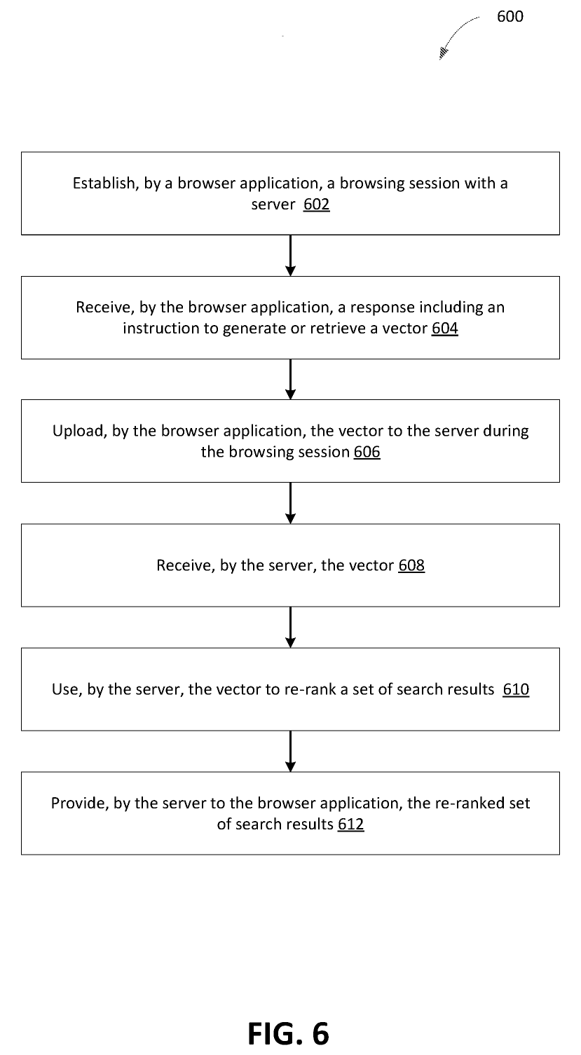

Reference will now be made to FIG. 6, which illustrates an example method 600 for uploading a vector to a server and using the uploaded vector. The method 600 may be implemented by one or more computer systems suitably programmed to carry out the functions described. The operations of the example method 600 may be performed by one or more computer systems which may be of the type described herein. In some embodiments, one or more of the operations may be carried out by the client system 102 and the application server 104 in the example operating environment 100 described in FIG. 1. In this example, the client device 120 may be referred to as a computing device and the application server may be referred to as a computing system. In some embodiments, aspects of one or more operations 602 and 604 may be carried out by a software application installed on the computing device. The software application may be a browser application. The client device may be configured to communicate with a data facility 300 of FIG. 3 and receive or respond to communications from a server.

In operation 602, the client device may establish a browsing session with a server. The establishment of the browsing session may be triggered when the client device receives an instruction to initiate an interaction with and/or connect with the server. The instruction may correspond to or be based on input received at an input interface. For example, the instruction may correspond to or be triggered by an activation of a link displayed in a browser application on the client device. The activation of the link may trigger the browser application to transmit a Hypertext Transfer Protocol (HTTP) request to retrieve a webpage of a website. The browsing session may commence when the application server receives the request from the client device. Upon receiving the request, the application system may generate a session identifier and, in reply, send the requested webpage along with the session identifier.

The browsing session may be an authenticated or unauthenticated session. An authenticated browsing session may be a browsing session in which the identity of the user that is browsing has been verified by the server. For example, a user identity may be verified by the server through receiving and authenticating user login credentials from the client device. The login credentials may include a username and password combination, biometric information, or other credential data. An unauthenticated browsing session may be a browsing session in which the identity of a user associated with the browsing session has been not verified by the server.

In operation 604, the browser application receives a response from the server. The response may include an instruction to generate and/or retrieve a vector. The instruction may be in the form of code that is executed by the browser application.

The execution of the instruction may be triggered by various events. For example, instruction may be automatically executed in response to loading a webpage corresponding to the response. By way of another example, the instruction may be triggered by input indicating activation of a link included in webpage corresponding to the response.

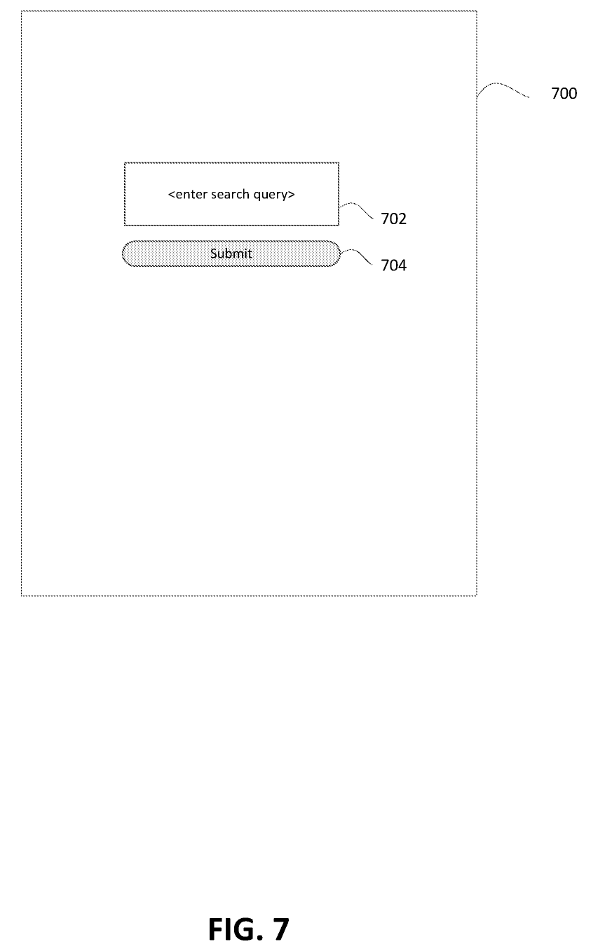

Referring briefly to FIG. 7, an example search interface 700 is illustrated. The example search interface 700 may be displayed at the client device in the browser application after an address associated with the search interface 700 is input into the browser application. The search interface 700 includes an input area 702 for receiving data representing a search query. The search interface 700 also includes a selectable option 704 that may be activated in order to trigger the generation and/or retrieval of the vector. In addition, activation of the selectable option 704 may also trigger the sending of the search query, as well as the vector, from the client device to the server performing the method 600 of FIG. 6.

Referring back to FIG. 6, in operation 606, the browser application may, during the browsing session, upload the vector to the server. The uploaded vector may be cached by the browser application so that the vector is not regenerated each time the webpage is revisited. The same vector may be uploaded to a plurality of distinct and disparate computer systems that are operated by respective third parties.

The vector may be uploaded without uploading the user data and/or any answer in the set of answers. The content of the user data and/or set of answers may not be uploaded to the server at any point in time during the browsing session. By way of example, the user data and/or set of answers may include content such as text, image, audio, or video data, but that text, image, audio, or video data, as well as the underlying words or pixels of that data, may not be transmitted to the server.

In operation 608, the server may receive the search query and vector, which may trigger one or more actions. In some embodiments, the server may use the vector to re-rank search results. For example, in operation 610, the server may use the search query to perform a search and generate a result list ordered by relevance. The server may then compute a vector embedding for each item in the result list based on, for example, the title and description of a particular item. The server may re-rank the items by comparing the uploaded vector with the vectors created for the retrieved items and return the top-k most similar ones. Vector search algorithms that may be used include k-Nearest Neighbors (kNN) and (ANN) Approximate Nearest Neighbors. In operation 612, the server may transmit the re-ranked search results to client device, which may display the re-ranked search results in the browser application.

The example methods 500 and 600 of FIGS. 5 and 6 provide an approach for generating a vector on a client device and uploading that vector to a server to facilitate the generation of personalized search results.

The client-side generation of the vector may also allow a browser application to provide a representation of the user data to a server without exposing local, sensitive, private, and/or voluminous user data to the server via the client-side model. Only the vector and not the model generated answers or the data the answers were generated from may cross a trust boundary. The trust boundary may exist between the client device and the server, or between different tabs in the browser application, and be based on a domain name, session, or other information.

The techniques described herein may also provide a two-layer approach to addressing privacy concerns associated with uploading personal data. A user may, via a policy, select the user data to be used on the client-side, which may provide a first layer of privacy. The vector produced may provide an additional layer of privacy. In particular, the vector may be a numerical representation of data and an encoding of features or semantic meaning of the data, rather than the actual contents of the data such as underlying words or pixels. In this way, the vector may not provide any direct user information to the server as the user data itself is not transferred to the server. In at least some implementations, the vector may be transferred to the server without transferring or providing any user data and/or generated answers to the server.

The techniques described herein may also provide an approach to addressing technical concerns associated with uploading large amounts of user data. The vector produced may be significantly smaller than the data upon which it is based. In some embodiments, the vector may be one or more orders of magnitude smaller than the user data. For example, the user data may be several megabytes or gigabytes in size, whereas a vector may be in the range of one to four kilobytes in size. For example, a vector with 2,048 dimensions and in an eight-bit integer format, sometimes referred to as INT8, or a one-byte format, may be two kilobytes in size. By way of another example, a vector with 1,024 dimensions and a 32-bit floating point format, sometimes referred to as FP32 or float32, or a four-byte format, may be four kilobytes in size.

In addition, the vector may be particularly beneficial in scenarios where computing resources are limited. The vector may be cached and uploaded to different servers and across different sessions, which may reduce the use of computing resources by reducing the use of the client-side model. This may be especially beneficial where the client device is a mobile device that has limited battery power, computing resources and/or is a device that has general hardware rather than specialized hardware for running a local model. This may also facilitate implementations that are more lightweight than techniques that require sending user data to a server.

It will be appreciated that it may be that some or all of the above-described operations of the various above-described example methods may be performed in orders other than those illustrated and/or may be performed concurrently without varying the overall operation of those methods.

It will also be appreciated that some or all of the above-described operations of the various above-described example methods may be triggered by, or caused by, or performed in response to, one or more of the above-described operations, and may be performed in real-time or near real-time in response to one or more of the above-described operations and/or automatically without user input.

Although many of the above examples refer to an “object” when discussing a data structure, it will be appreciated that this does not necessarily restrict the present application to implementation using object-oriented programming languages, and does not necessarily imply that the data structure is of a particular type or format. Data structures may have different names in different software paradigms.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

### Implementations

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In some embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4th Generation (4G) networks (e.g., Long-Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer system comprising:
a communications module;
a processor; and
a memory storing instructions that, when executed by the computer system, cause the computer system to:
obtain user data and a set of defined queries;
generate a set of answers to the set of defined queries, the generation including causing a model to create, based on the user data and the set of defined queries, the set of answers;
use an embedding model to generate a vector based on the set of answers; and
upload, by a browser application using the communications module, the vector to a server during a browsing session.

2. The computer system of claim 1, wherein the vector is based on embeddings of some or all of the answers.

3. The computer system of claim 1, wherein the vector is a vector of embeddings of some or all of the answers.

4. The computer system of claim 1, wherein the user data includes sensor data.

5. The computer system of claim 1, wherein the user data includes a browsing history of the browser application.

6. The computer system of claim 1, wherein the user data includes data obtained from a third-party computer system.

7. The computer system of claim 1, wherein at least a portion of the user data is obtained based on a recency threshold.

8. The computer system of claim 1, wherein the instructions further cause the computer system to upload the vector to a plurality of computer systems.

9. The computer system of claim 1, wherein the instructions further cause the computer system to:
update a subset of answers in the set of answers; and
update the vector based on the set of answers including the updated subset of answers.

10. The computer system of claim 1, wherein the instructions further cause the computer system to update the vector in response to an interaction between the browser application and a webpage.

11. A computer-implemented method comprising:
obtaining user data and a set of defined queries;
generating a set of answers to the set of defined queries, the generation including causing a model to create, based on the user data and the set of defined queries, the set of answers;
using an embedding model to generate a vector based on the set of answers; and
uploading, by a browser application, the vector to a server during a browsing session.

12. The method of claim 11, wherein the vector is based on embeddings of some or all of the answers.

13. The method of claim 11, wherein the vector is a vector of embeddings of some or all of the answers.

14. The method of claim 11, wherein the user data includes sensor data.

15. The method of claim 11, wherein the user data includes a browsing history of the browser application.

16. The method of claim 11, wherein the user data includes data obtained from a third-party computer system.

17. The method of claim 11, wherein at least a portion of the user data is obtained based on a recency threshold.

18. The method of claim 11, further comprising uploading the vector to a plurality of computer systems.

19. The method of claim 11, further comprising:
updating a subset of answers in the set of answers; and
updating the vector based on the set of answers including the updated subset of answers.

20. A non-transitory computer-readable storage medium storing processor-executable instructions which, when executed by a processor of a computer system, cause the computer system to:
obtain user data and a set of defined queries;
generate a set of answers to the set of defined queries, the generation including causing a model to create, based on the user data and the set of defined queries, the set of answers;
use an embedding model to generate a vector based on the set of answers; and
upload, by a browser application, the vector to a server during a browsing session.
